(19) United States
(12) Patent Application Publication
(10) Pub. No.: US 2012/0303655 A1
(43) Pub. Date: Nov. 29, 2012

(54) System and Method for Reviewing and Editing Article-Related List

(75) Inventor: Steven Douglas Gullion, Sugar Land, TX (US)

(73) Assignee: BRIDGEWAY SOFTWARE, INC., Bellaire, TX (US)

(21) Appl. No.: 13/116,673

(22) Filed: May 26, 2011

(51) Int. Cl. G06F 17/30

(52) U.S. Cl. 707/769; 707/E17.014

(57) ABSTRACT

Systems, methods and computer readable media for reviewing and editing a list of action items related to an article are described. A link is inserted to an article web page. The link, when clicked by a user, invokes a function on a central server. Action items for the article are retrieved from a database and displayed to the user. The user can manipulate the action items to create his own checklist, and copy/print the checklist, or email the checklist. If the user has an account on a management system on the central server, the user can send the checklist to the management system and insert the list into his master list of action items.

### BACKGROUND

This disclosure relates generally to the field of computing. More particularly, but not by way of limitation, this disclosure relates to a technique for reviewing and editing a list of items associated with an article.

Nowadays, the Internet has become part of people's everyday life. More and more people read news and articles online. When a reader reads an article, oftentimes the reader may want to take notes of those topics interesting to him/her in the article. For example, if a reader is reading an article about job hunting, he may want to take notes of job searching tips provided in the article. The reader may want to share the notes with friends and colleagues. The reader may also want to add some of these tips to his/her “to do” list. However, there are no existing tools for a reader to readily review and edit a list of items related to an article. The reader may have to derive those tips from the article himself, and rely on old fashioned pen and paper to write them down; or manually type notes into a computer.

### SUMMARY

Various embodiments disclose systems, methods and computer readable media for reviewing and editing a list of action items related to an article. A link is inserted into an article web page. The link, when clicked by a user, invokes a function on a central server. Action items for the article are retrieved from a database and displayed to the user. The user can manipulate the action items to create his own checklist, copy/print the checklist, or email the checklist. If the user has an account on a management system on the central server, the user can send the checklist to the management system and insert the list into his master list of action items.

In another embodiment, a system that allows a user to review and/or edit a list of action items related to an article is disclosed. The system includes a hosting server that publishes an article to a web page, and a central server that receives a request from the user, retrieves data associated with the article from a database, displays the data to the user, and saves selection made by the user to the database.

In still another embodiment, a non-transitory computer readable medium is disclosed wherein the non-transitory computer readable medium (i.e., a program storage device) has instructions for causing a programmable control device to perform a method described above.

In yet another embodiment, a networked computer system is disclosed that includes a plurality of computers communicatively coupled, at least one of the plurality of computers programmed to perform at least a portion of a method described above wherein the entire method is performed collectively by the plurality of computers.

### BRIEF DESCRIPTION OF THE DRAWINGS

FIG. 1 illustrates an exemplary system that implements techniques disclosed herein.

FIG. 2 illustrates, in block diagram form, an example process implementing techniques disclosed herein.

FIG. 3 illustrates an example article web page that includes a link to review and/or edit a list of action items related to an article.

FIG. 4 illustrates an example screen that displays a list of action items related to an article for a user to review and/or edit.

FIG. 5 illustrates another example screen that allows a user to add new action items.

FIG. 6 illustrates an example screen that allows a user to select a folder and/or a delegate for action items.

FIG. 7 illustrates, in flowchart form, a method for reviewing and editing article-related list according to one embodiment.

FIG. 8 illustrates, in block diagram form, an example computer system that may be utilized to implement various embodiments disclosed herein.

### DETAILED DESCRIPTION

Various embodiments disclose systems, methods and computer readable media for reviewing and editing a list of action items related to an article. A list of action items are derived from an article and saved in a database. An administrator at a hosting server inserts a link on a webpage that publishes an article. The link, when clicked by a user, invokes a function on a central server, and passes a predefined ID that identifies the article to the central server. Action items related to the article are retrieved from the database based on the ID and are displayed back to a user. The user can manipulate the action items, including adding new action items, to create his own checklist. The user can copy/print the checklist or email the checklist. If the user has an account on a management system on the central server, the user can send the checklist to the management system and insert the list into his master list of action items. The user may select a folder to save the action items. The user may also assign the action items to one or more delegates.

In the following description, for purposes of explanation, numerous specific details are set forth in order to provide a thorough understanding of the invention. It will be apparent to one skilled in the art, however, that the invention may be practiced without these specific details. In other instances, structure and devices are shown in block diagram form in order to avoid obscuring the invention. It will be appreciated that in the development of any actual implementation (as in any development project), numerous decisions must be made to achieve the developers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the art having the benefit of this disclosure. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

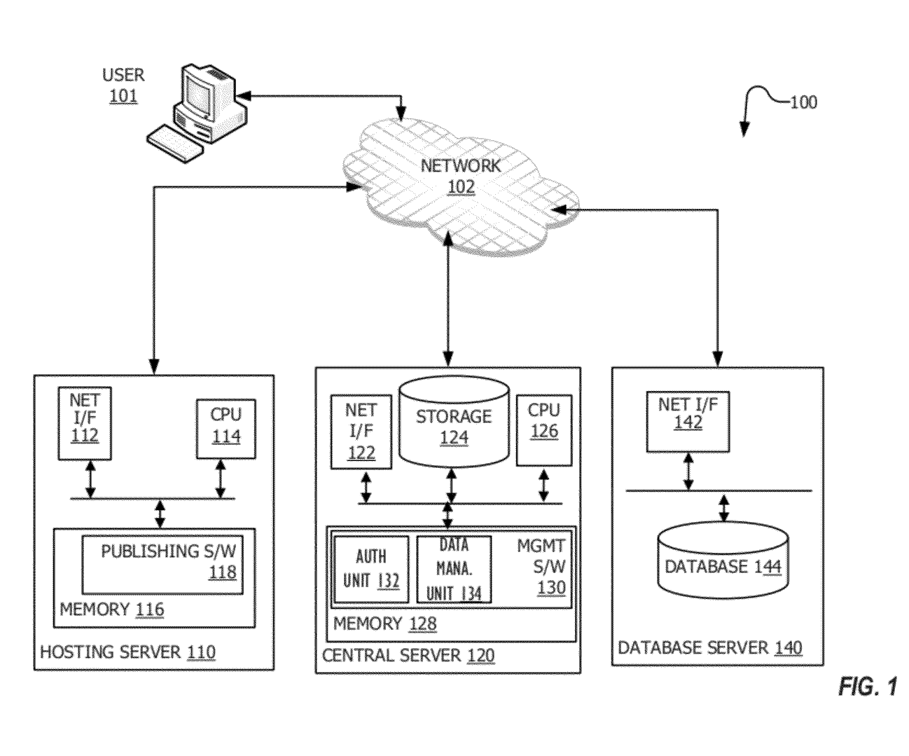

FIG. 1 illustrates example system 100 that implements techniques for reviewing and editing article-related lists disclosed in this paper. System 100 includes hosting server 110 coupled to network 102, which provides connectivity between hosting server 110, one or more user nodes 101, central server 120 and database server 140. Such connectivity is provided via each system's network interface (e.g., network interfaces 112, 122 and 142). Hosting server 110 includes publishing software 118 which is loaded into memory 116 and executed by CPU 114. Hosting server 110 publishes an article to a web page accessible by user 101. The web page contains a link to certain functions on central server 120. Clicking the link invokes the corresponding functions on central server 120.

Example central server 120 includes management software 130 which is loaded into memory 128 and executed by CPU 126. Central server 120 also includes persistent storage device 124 (e.g., a hard disk drive), used to store configuration settings of management software 130. Central server 120 communicates with database server 140, retrieves data from database 144 and displays data to user 101, and saves user selections into database 144.

Management software 130 comprises a collection of functional blocks, e.g., authentication unit 132 and data management unit 134. Each functional block may be implemented as a separate software component using, for example, any number of conventional programming languages including C, C++, Java °, and so on. (Java is a registered trademark of the Oracle Cooperation.) Furthermore, it will be appreciated by those skilled in the art that not every embodiment require every functional block shown in FIG. 1, or may include additional functional blocks which have been left out of FIG. 1 to avoid obscuring the disclosed embodiment with unnecessary detail. Software code modules implementing the functional blocks and representing system 100 may reside and execute on a single machine, or may be distributed in some meaningful manner to reside and execute on multiple machines.

The network 102 would commonly include the Internet and local area networks (LANs) for the various components and services. Usually the users would be on the individual LANs, the hosting server 110 would be on its own LAN and the central server 120 and the database server 140 would be on a common LAN, with all the LANs connected to the Internet. Of course, other network variations could be used.

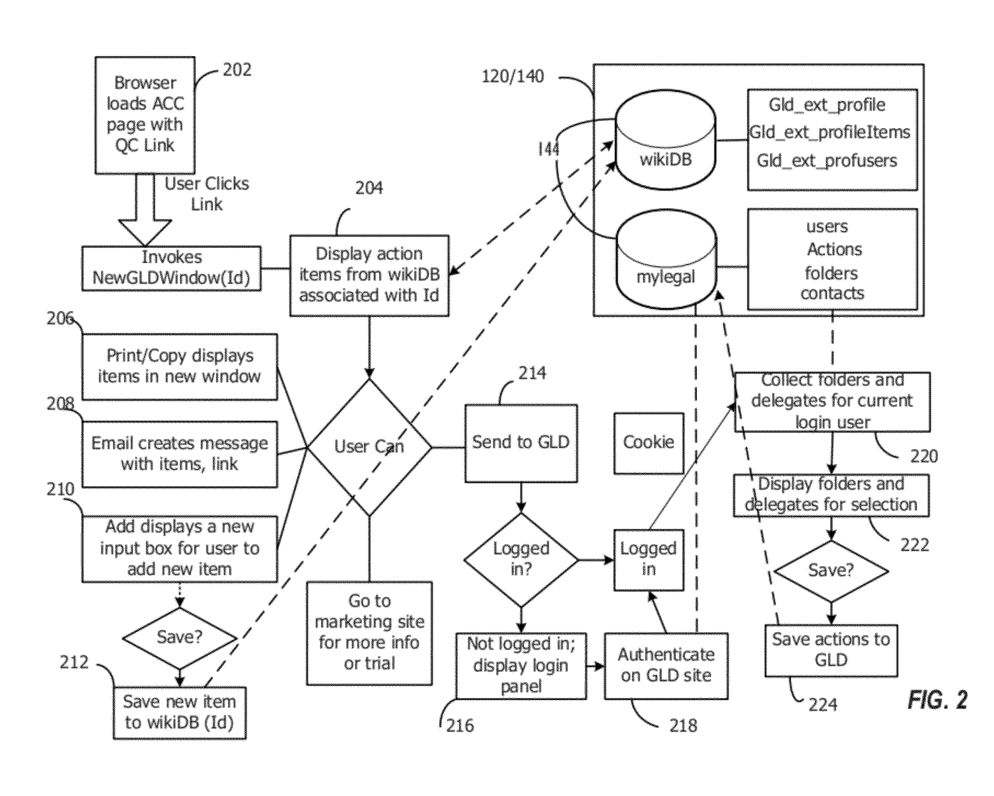

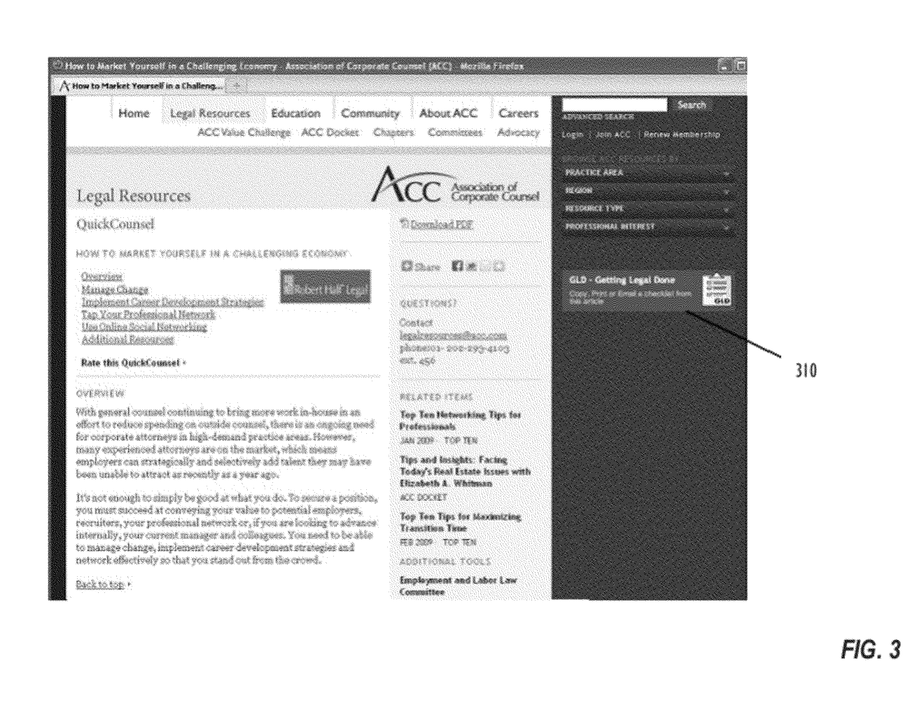

FIG. 2 illustrates an example process implementing techniques disclosed herein. At block 202, a user 101 visits an article web page that includes a review/edit link. When hosting server 110 publishes an article on a web page, it may also insert a link on that web page. In one embodiment, the link references a functional script (e.g., JavaScript) located on central server 120. The link may also include a predefined identification number (ID) that identifies the web page. The identification numbers may be predefined by management software 130. An ID is assigned for an article on the calling web page, and is associated with a list of bullet points that summarize the article stored in database 144. In one embodiment, the author or the publisher of an article may provide the list of bullet points of the article to an administrator of central server; the administrator assigns an identification number to the article (calling page) and saves the list to database. The administrator provides the identification number to the publisher to include in the link. When the web browser on the user's terminal loads the web page, it also displays the link on the web page. An example article web page containing a link is shown in FIG. 3. The link 310 allows a user to review and/or edit a list of action items related to the article, which will be describe in detail below.

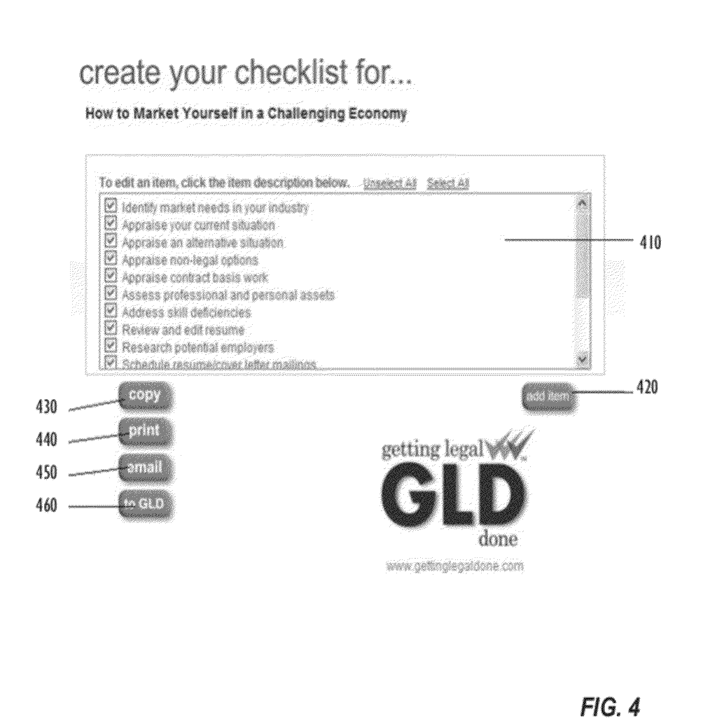

When the user clicks the link 310, a list of action items related to the article is retrieved from the database 144 and displayed to the user, block 204. The list of action items may be displayed in a new window. When the link is clicked, a JavaScript function invokes a PHP function on the central server 120, and the article ID is also passed to the central server 120. The PHP function then uses the ID to look up information associated with the ID in the database. In one embodiment, a request for a list of action items associated with the article is sent to the central server when the link is clicked. The management software 130 receives the request. If there are records in the database 144 associated with the article ID, those records are retrieved from the database 144. In one embodiment, a PHP page is invoked to handle the data retrieval process. The PHP page constructs an HTML/JavaScript fragment using the data retrieved. The HTML/JavaScript fragment is then inserted into the calling page and displayed to the user in a new window. An example screen of the window that displays the list of action items related to the article is shown in FIG. 4. As shown, action items related to the article are displayed in the checklist box 410.

A user can then select/deselect action items from the list to create his/her own checklist. Features such as “select all” and “unselect all” may also be provided to the user for ease of manipulation. After a user finishes selecting action items to create his checklist, the user can copy, print or email the checklist, blocks 206 and 208. The copy, print or email actions are carried out through “Copy” button 430, “Print” button 440, and “Email” button 450 shown in FIG. 4. The Print and Copy actions display the selected items in a new window. A user can print or copy the content from the new window. The Email action opens a “new message” window using the default mail service in the user's environment. The new message is prefilled with the checklist created by the user. The user may provide recipients to the new message and send out the email. The user may also edit the email message before sending it out if he/she chooses to.

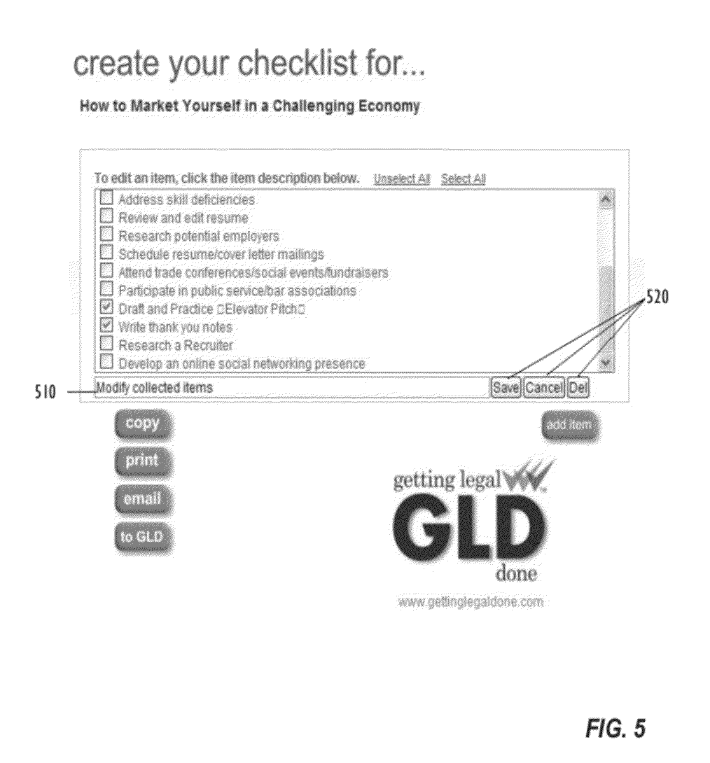

A user may also add new action items into the list of action items, block 210. The Add action is carried out via the “Add Item” button 420 as shown in FIG. 4. When the “Add Item” button 420 is pressed, a new input box 510 is shown to the user along with “Save”, “Cancel” and “Delete” buttons 520, as shown in FIG. 5. A user may type a new action item in input box 510, the new action item is then added to the existing list and displayed in checklist box 410 if the “Save” button is pressed. The “Delete” button allows a user to delete a recently added item in the list. The “Cancel” button lets the user exit the screen.

The newly added action items may be stored in the browser memory. In one embodiment, the newly added action items are sent to the central server 120. The new action items are then associated with the article ID and stored in the database 144 for future use, block 212.

If a user has an account on the central server 120, the user can send his/her checklist to the central server 120 and add the list of action items to his master list of action items, block 214. The “to GLD” button 460 shown in FIG. 4 is designed for this purpose. Getting Legal Done (GLD) is a cloud based matter management system developed by Bridgeway Software. A GLD account has a root folder. A master list of action items for the account may be placed under the root directory. A GLD user may also create his own folders to organize his tasks. A GLD user may also have one or more delegates (colleagues or coworkers) if the user has permission to delegate tasks to his coworkers.

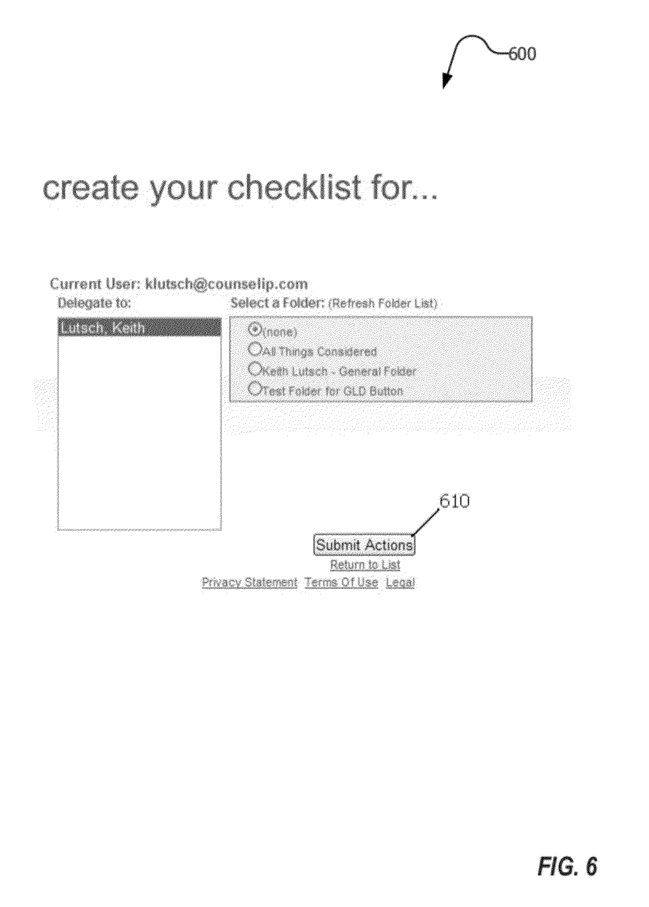

After “to GLD” button 460 is pressed, if the user is not logged in to his GLD account, a login screen may be shown, block 216, as evidenced by lack of a selected cookie, for example. A returning GLD user may log in to GLD by providing his login credentials, such as login ID and password. The login credentials are then authenticated by the authentication unit 132 on the central server 120, block 218. If the login authentication succeeds, the user is directed to a page where he can make selections on where to send the list. An example screen after successful login is shown in FIG. 6. In one embodiment, login cookies are used to store information of previously successful login, and allow a user to go directly to the next page without going through logging again.

A user can then designate where the action items will be saved after the user is successfully logged in to GLD system.

After a successful login, the data management unit 134 retrieves folders and delegates for the logged in GLD user, block 220. At block 222, the retrieved folders and delegates are displayed back to the user, as shown in FIG. 6. A user may select a folder and save the action items into that folder. If a folder is not selected, the action items may be saved under the root folder of the login user account. A user may also want to assign the action items to one of his delegates by selecting a delegate. Once the user presses the submit button 610, the action items will be saved to the selected folder and assigned to the selected delegate (if selected) in the database 144, block 224. In one embodiment, the user interface allows the user to select certain action items and assign them to one delegate, and select other action items and assign them to another delegate.

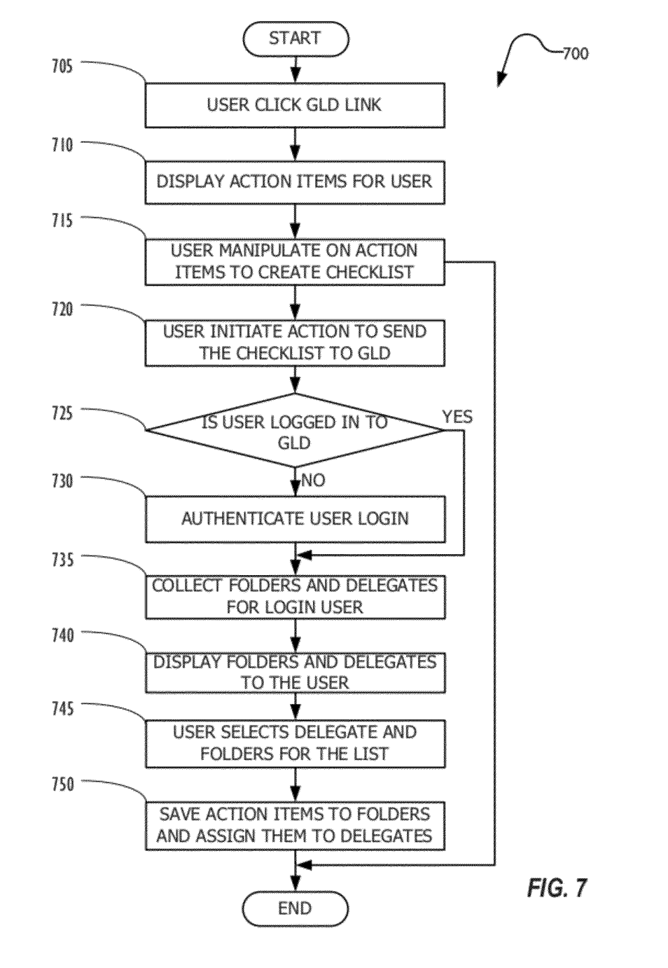

FIG. 7 illustrates in a more conventional format an example process 700 that reviews and edits a list of article-related action items. At block 705, when a user reads an article on a web page hosted by hosting server 110, the user clicks on the inserted GLD link. An action on central server 120 associated with link is invoked. The ID of the calling page is also passed to the central server. Management software 130 retrieves action items associated with the ID and displays them back to the user, block 710.

At block 715, the user reviews the action items, creates new action items, selects and/or deselects action items to create his own checklist. The user then can email the checklist, or print/copy the checklist. The user may not want to perform any more actions on the checklist, as such process 700 reaches the end of the process.

If the user also wants to save the checklist to GLD, the user initiates action to send the checklist to GLD, block 720. Management software 130 on central server 120 determines whether the user is already logged in to the GLD, block 725. If the user is already logged in, process 700 then collects folders and delegates for the login user, block 735. However, if the user is not logged in yet, system provides a user interface for the user to submit login credentials, and authenticates the login credentials against the records in database, block 730.

After the user login authentication, management software 130 retrieves folders and delegates for the login user from the database, block 735. Folders and delegates for the login user are then constructed in an HTML segment and displayed back to the user, block 740. The user may select a folder to save the checklist, the user may also select a delegate to assign the list to, block 745. Once the user submits, the action items are saved in the selected folder, and are assigned to the selected delegate if a delegate is selected, block 750.

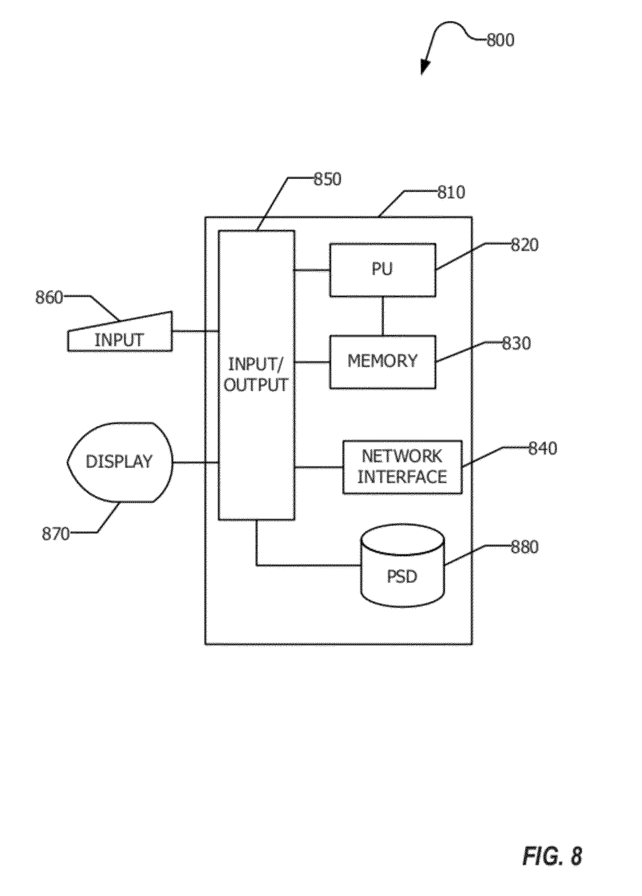

FIG. 8 shows example computer system 800. Example computer system 800 may be used as hosting server 110 or central server 120. Example computer system 800 comprises system unit 810 which may be optionally connected to input device 860 (e.g., keyboard, mouse, touch screen, etc.) and display 870. Program storage device (PSD) 880 is included within system unit 810. Also included within system unit 810 is network interface 840 for communication with other devices via a network (not shown). Network interface 840 may be included within system unit 810 or be external to system unit 810. In either case, system unit 810 may be communicatively coupled to network interface 840. Program storage device 880 represents any form of non-volatile storage including, but not limited to, all forms of optical and magnetic storage, including solid-state storage elements and removable media. Program storage device 880 may be used for storage of software to control system unit 810, data for use by computer system 800, or both.

System unit 810 may be programmed to perform methods in accordance with this disclosure (an example of which is shown in FIG. 7). System unit 810 comprises processor unit (PU) 820, input-output (I/O) interface 850 and memory 830. Processing unit 820 may include any programmable controller device including, for example, one or more members of the Intel Atom®, Core®, Pentium and Celeron® processor families from Intel and the Cortex and ARM processor families from ARM. (INTEL, INTEL ATOM, CORE, PENTIUM, and CELERON are registered trademarks of the Intel Corporation. CORTEX is a registered trademark of the ARM Limited Corporation. ARM is a registered trademark of the ARM Limited Company.) Memory 830 may include one or more memory modules and comprise random access memory (RAM), read only memory (ROM), programmable read only memory (PROM), programmable read-write memory, and solid-state memory. One of ordinary skill in the art will also recognize that PU 820 may also include some internal memory including, for example, cache memory.

In addition, acts in accordance with the method of FIG. 7 may be performed by example computer system 800 including a single computer processor, a plurality of processors coupled by a communications link or a custom designed state machine, or other device capable of executing instructions organized into one or more program modules. Custom designed state machines may be embodied in a hardware device such as an integrated circuit including, but not limited to, application specific integrated circuits (“ASICs”) or field programmable gate array (“FPGAs”).

Various changes in the components as well as in the details of the illustrated operational method are possible without departing from the scope of the following claims. For example, the illustrative system of FIG. 1 may be comprised of more than one computer communicatively coupled via a communication network, wherein the computers may be mainframe computers, minicomputers, workstations or any combination of these. Further, monitored applications may execute on multiple hardware platforms. Such a network may be composed of one or more local area networks, one or more wide area networks, or a combination of local and wide-area networks. In addition, the networks may employ any desired communication protocol and further may be “wired” or “wireless.” Acts in accordance with FIG. 7 may be performed by a programmable control device executing instructions organized into one or more program modules. A programmable control device may be a single computer processor, a special purpose processor (e.g., a digital signal processor, “DSP”), a plurality of processors coupled by a communications link or a custom designed state machine. Custom designed state machines may be embodied in a hardware device such as an integrated circuit including, but not limited to, application specific integrated circuits (“ASICs”) or field programmable gate array (“FPGAs”). Storage devices suitable for tangibly embodying program instructions include, but are not limited to: magnetic disks (fixed, floppy, and removable) and tape; optical media such as CD-ROMs and digital video disks (“DVDs”); and semiconductor memory devices such as Electrically Programmable Read-Only Memory (“EPROM”), Electrically Erasable Programmable Read-Only Memory (“EEPROM”), Programmable Gate Arrays and flash devices.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

What is claimed is:

1. A computer-implemented method of reviewing and editing a list of action items related to an article, the method comprising:
receiving a request from a user to review action items related to an article, wherein the article is published by a host server, the article including a link to request the review of the action items and the request provided when the user selects the link;
retrieving a list of action items related to the article from a database;
providing the list of action items for display to the user;
receiving a checklist of action items selected by the user; and
saving the received checklist in the database.

2. The computer-implemented method of claim 1 further comprising:
authenticating the user on a management system with login credentials;
retrieving a list of folders and delegates associated with the user after being authenticated; and
providing the retrieved list of folders and delegates for display to the user.

3. The computer-implemented method of claim 2 further comprising receiving a folder selected by the user, and wherein the act of saving the received checklist comprises saving the receiving checklist to the selected folder in the database.

4. The computer-implemented method of claim 2 further comprising:
receiving a delegate selected by the user to assign the checklist; and
storing the assignment in the database for retrieval by the selected delegate.

5. The computer-implemented method of claim 2 further comprising:
receiving a first delegate selected by the user to assign a first one or more action items;
receiving a second delegate selected by the user to assign a second one or more action items; and
storing the assignments in the database for retrieval by the first and second delegates.

6. The computer-implemented method of claim 1 further comprising:
receiving one or more action items added by the user; and
associating the received one or more action items with the article; and
storing the received one or more action items in the database.

7. The computer-implemented method of claim 6, wherein the act of retrieving a list of action items related to the article comprises retrieving the one or more action items added by the user.

8. A computer-implemented method of reviewing and editing a list of action items related to an article, the method comprising:
sending, by a user, a request to review action items related to an article, wherein the article is published by a host server;
receiving the request at a central server;
retrieving, at the central server, a list of action items related to the article from a database;
displaying the list of action items to the user;
selecting, by the user, one or more action items to create a checklist; and
performing actions on the checklist.

9. The computer-implemented method of claim 8, wherein the act of performing actions on the checklist comprises copying, printing or emailing the checklist.

10. The computer-implemented method of claim 8, wherein the act of performing actions on the checklist comprises sending the checklist to a management system on the central server.

11. The computer-implemented method of claim 10, wherein the act of sending the checklist to a management system comprises:
authenticating the user on the management system with login credentials;
retrieving a list of folders and delegates associated with the user after being authenticated;
displaying the retrieved list of folders and delegates to the user;
selecting, by the user, a folder to save the checklist; and
saving the checklist to the selected folder in the database.

12. The computer-implemented method of claim 11 wherein the act of sending the checklist to a management system further comprises:
selecting, by the user, a delegate to assign the checklist; and
storing the assignment in the database for retrieval by the delegate.

13. The computer-implemented method of claim 11 wherein the act of sending the checklist to a management system further comprises:
selecting a first one or more action items;
assigning the first one or more action items to a first delegate;
selecting a second one or more action items;
assigning the second one or more action items to a second delegate; and
storing the selections in the database for retrieval by the first and second delegates.

14. The computer-implemented method of claim 8 further comprising adding one or more new action items defined by the user to the list of action items which may be selected to update the checklist.

15. The computer-implemented method of claim 14 further comprising storing the one or more new action items defined by the user in the database.

16. A computer-implemented method of reviewing and editing a list of action items related to an article, the method comprising:
sending a request to review action items related to an article to a central server, wherein the article is published by a host server, the article including a link to request the review of the action items and the request provided when a user selects the link;
receiving, from the central server, a list of action items related to the article retrieved from a database;
displaying the list of action items;
receiving selections of one or more action items from the list of action items to create a checklist; and
performing actions on the checklist.

17. The computer-implemented method of claim 16, wherein the act of performing actions on the checklist comprises copying, printing or emailing the checklist.

18. The computer-implemented method of claim 16, wherein the act of performing actions on the checklist comprises sending the checklist to a management system on the central server.

19. The computer-implemented method of claim 18, wherein the act of sending the checklist to a management system comprises:
providing login credentials to authenticate the user on the management system;
receiving a list of folders and delegates associated with the user after being authenticated;
displaying the received list of folders and delegates;
receiving a selection of a folder to save the checklist; and
sending the selection to the central server to save in the database.

20. The computer-implemented method of claim 19 wherein the act of sending the checklist to a management system further comprises:
receiving an assignment of the checklist to a delegate; and
sending the assignment to the central server to save in the database.

21. The computer-implemented method of claim 19 wherein the act of sending the checklist to a management system further comprises:
receiving a selection of a first one or more action items;
receiving an assignment of the first one or more action items to a first delegate;
receiving a selection of a second one or more action items;
receiving an assignment of the second one or more action items to a second delegate; and
sending the assignments to the central server to save in the database.

22. The computer-implemented method of claim 16 further comprising receiving one or more new action items defined by the user to be added to the list of action items which may be selected to update the checklist.

23. The computer-implemented method of claim 22 further comprising sending the one or more new action items defined by the user to the central server to save in the database.

24. A computer program product comprising a tangible computer readable medium storing program code for causing a programmable control device to perform an operation for reviewing and editing a list of action items related to an article, the program code comprising:
program code for receiving a request from a user to review action items related to an article, wherein the article is published by a host server, the article including a link to request the review of the action items and the request provided when the user selects the link;
program code for retrieving a list of action items related to the article from a database;
program code for providing the list of action items for display to the user;
program code for receiving a checklist of action items selected by the user; and
program code for saving the received checklist in the database.

25. The computer program product of claim 24, wherein the program code further comprising:
program code for authenticating the user on a management system with login credentials;
program code for retrieving a list of folders and delegates associated with the user after being authenticated; and
program code for providing the retrieved list of folders and delegates for display to the user

26. The computer program product of claim 25, wherein the program code further comprising program code for receiving a folder selected by the user, and wherein the program code for saving the received checklist comprises program code for saving the receiving checklist to the selected folder in the database.

27. The computer program product of claim 25, wherein the program code further comprising:
program code for receiving a delegate selected by the user to assign the checklist; and
program code for storing the assignment in the database for retrieval by the selected delegate.

28. The computer program product of claim 25, wherein the program code further comprising:
program code for receiving a first delegate selected by the user to assign a first one or more action items;
program code for receiving a second delegate selected by the user to assign a second one or more action items; and
program code for storing the assignments in the database for retrieval by the first and second delegates.

29. The computer program product of claim 24, wherein the program code further comprising:
program code for receiving one or more action items added by the user;
program code for associating the received one or more action items with the article; and
program code for storing the received one or more action items in the database.

30. The computer program product of claim 24, wherein the program code for retrieving a list of action items related to the article comprises program code for retrieving the one or more action items added by the user.

31. A computer program product comprising a tangible computer readable medium storing program code for causing a programmable control device to perform an operation for reviewing and editing a list of action items related to an article, the program code comprising:
program code for sending a request to review action items related to an article to a central server, wherein the article is published by a host server, the article including a link to request the review of the action items and the request provided when a user selects the link;
program code for receiving, from the central server, a list of action items related to the article retrieved from a database;
program code for displaying the list of action items;
program code for receiving selections of one or more action items from the list of action items to create a checklist; and
program code for performing actions on the checklist.

32. The computer program product of claim 31, wherein the program code for performing actions on the checklist comprises program code for copying, printing or emailing the checklist.

33. The computer program product of claim 31, wherein the program code for performing actions on the checklist comprises program code for sending the checklist to a management system on the central server.

34. The computer program product of claim 33, wherein the program code for sending the checklist to a management system comprises:
program code for providing login credentials to authenticate the user on the management system;
program code for receiving a list of folders and delegates associated with the user after being authenticated;
program code for displaying the received list of folders and delegates;
program code for receiving a selection of a folder to save the checklist; and
program code for sending the selection to the central server to save in the database.

35. The computer program product of claim 34, wherein the program code for sending the checklist to a management system comprises:
program code for receiving an assignment of the checklist to a delegate; and
program code for sending the assignment to the central server to save in the database.

36. The computer program product of claim 34, wherein the program code for sending the checklist to a management system comprises:
program code for receiving a selection of a first one or more action items;
program code for receiving an assignment of the first one or more action items to a first delegate;
program code for receiving a selection of a second one or more action items;
program code for receiving an assignment of the second one or more action items to a second delegate; and
program code for sending the assignments to the central server to save in the database.

37. The computer program product of claim 31, wherein the program code further comprising program code for receiving one or more new action items defined by the user to be added to the list of action items which may be selected to update the checklist.

38. The computer program product of claim 37, wherein the program code further comprising program code for sending the one or more new action items defined by the user to the central server to save in the database.

39. A computer-implemented system providing a reader to review and edit a list of action items related to an article, the system comprising:
a processor;
a storage device operatively coupled to the processor; and
a software module stored in the storage device, the software module comprising instructions that when executed by the processor cause the processor to perform:
receive a request from a user to review action items related to an article, wherein the article is published by a host server, the article including a link to request the review of the action items and the request provided when the user selects the link;
retrieve a list of action items related to the article from a database;
provide the list of action items for display to the user;
receive a checklist of action items selected by the user; and
save the received checklist in the database.

40. The computer-implemented system of claim 39, wherein the software module further comprising instructions that when executed by the processor cause the processor to perform:
authenticate the user on a management system with login credentials;
retrieve a list of folders and delegates associated with the user after being authenticated; and
provide the retrieved list of folders and delegates for display to the user.

41. The computer-implemented system of claim 40, wherein the software module further comprising instructions that when executed by the processor cause the processor to perform:
receive a folder selected by the user; and
save the receiving checklist to the selected folder in the database.

42. The computer-implemented system of claim 40, wherein the software module further comprising instructions that when executed by the processor cause the processor to perform:
receive a delegate selected by the user to assign the checklist; and
store the assignment in the database for retrieval by the selected delegate.

43. The computer-implemented system of claim 40, wherein the software module further comprising instructions that when executed by the processor cause the processor to perform:
receive a first delegate selected by the user to assign a first one or more action items;
receive a second delegate selected by the user to assign a second one or more action items;
store the assignments in the database for retrieval by the first and second delegates.

44. The computer-implemented system of claim 39, wherein the software module further comprising instructions that when executed by the processor cause the processor to perform:
receive one or more action items added by the user; and
associate the received one or more action items with the article; and
store the received one or more action items in the database.

45. The computer-implemented system of claim 44, wherein the software module further comprising instructions that when executed by the processor cause the processor to retrieve the one or more action items added by the user.

46. A computer-implemented system providing a reader to review and edit a list of action items related to an article, the system comprising:
a processor;
a storage device operatively coupled to the processor; and
a software module stored in the storage device, the software module comprising instructions that when executed by the processor cause the processor to perform:
send a request to review action items related to an article to a central server, wherein the article is published by a host server, the article including a link to request the review of the action items and the request provided when a user selects the link;
receive, from the central server, a list of action items related to the article retrieved from a database;
display the list of action items;
receive selections of one or more action items from the list of action items to create a checklist; and
perform actions on the checklist.

47. The computer-implemented system of claim 46, wherein the software module further comprising instructions that when executed by the processor cause the processor to copy, print or email the checklist.

48. The computer-implemented system of claim 46, wherein the software module further comprising instructions that when executed by the processor cause the processor to send the checklist to a management system on the central server.

49. The computer-implemented system of claim 48, wherein the software module further comprising instructions that when executed by the processor cause the processor to perform:
provide login credentials to authenticate the user on the management system;
receive a list of folders and delegates associated with the user after being authenticated;
display the received list of folders and delegates;
receive a selection of a folder to save the checklist; and
send the selection to the central server to save in the database.

50. The computer-implemented system of claim 49, wherein the software module further comprising instructions that when executed by the processor cause the processor to:
receive an assignment of the checklist to a delegate; and
send the assignment to the central server to save in the database.

51. The computer-implemented system of claim 49, wherein the software module further comprising instructions that when executed by the processor cause the processor to:
receive a selection of a first one or more action items;
receive an assignment of the first one or more action items to a first delegate;
receive a selection of a second one or more action items;
receive an assignment of the second one or more action items to a second delegate; and
send the assignments to the central server to save in the database.

52. The computer-implemented system of claim 46, wherein the software module further comprising instructions that when executed by the processor cause the processor to receive one or more new action items defined by the user to be added to the list of action items which may be selected to update the checklist.

53. The computer-implemented system of claim 52, wherein the software module further comprising instructions that when executed by the processor cause the processor to send the one or more new action items defined by the user to the central server to save in the database.
